(19) United States
(12) Patent Application Publication
(10) Pub. No.: US 2007/0065944 A1
(43) Pub. Date: Mar. 22, 2007

(54) Stabilizing Griess reagent for explosives detection

(75) Inventors: Peter J. Nunes, Danville, CA (US); Adam H. Love, Berkeley, CA (US); M. Leslie Carman, San Ramon, CA (US); John G. Reynolds, San Ramon, CA (US)

Correspondence Address: Eddie E. Scott;Assistant Laboratory Counsel, Lawrence Livermore National Laboratory, P.O. Box 808, L-703, Livermore, CA, 94551, US

(73) Assignee: The Regents of the University of California

(21) Appl. No.: 11/501,375

(22) Filed: Aug. 8, 2006

Related U.S. Application Data
(60) Provisional application No. 60/706,911, filed on Aug. 9, 2005.

(51) Int. Cl. G01N 31/00

(52) U.S. Cl. 436/8

(57) ABSTRACT

The present invention provides a system wherein the Griess reagent has the ambient atmosphere removed. The present invention provides a system to treat the Griess reagent to improve storage lifetimes at room temperature or higher to over a year or more. The present invention greatly extends the useful lifetime of preparations of the Griess reagent as well as broadens the applications to field testing equipment.

### CROSS-REFERENCE TO RELATED APPLICATIONS

This application claims the benefit of U.S. Provisional Patent Application No. 60/706,911 filed Aug. 9, 2005 and titled “Stabilizing Griess Reagent for Explosives Detection.” U.S. Provisional Patent Application No. 60/60/706,911 filed Aug. 9, 2005 and titled “Stabilizing Griess Reagent for Explosives Detection” is incorporated herein by this reference.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to detecting explosives and more particularly to a stabilizing Griess reagent for explosives detection.

2. State of Technology

U.S. Pat. No. 5,638,166 for an apparatus and method for detection of explosives issued Jun. 10, 1997 to Herbert Funsten and David McComas provides the following state of the art information: “Explosives are a core component of nuclear, biological, chemical and conventional weapons, as well as of terrorist devices such as car, luggage, and letter bombs. Current methods for detecting the presence of explosives include vapor detection, bulk detection, and tagging . . . . It is known that surfaces in contact with explosives (for example, during storage, handling, or device fabrication) will readily become contaminated with explosive particulates as a result of their inherent stickiness . . . . Furthermore, cross contamination in which a secondary surface is contaminated by contact with a contaminated primary surface can also readily occur . . . . Therefore, explosive residue will likely persist in large amounts on the explosive packaging and environs, as well as on the individuals involved in building the explosive device, which can provide an avenue for detection of the presence of explosives.”

U.S. Pat. No. 5,679,584 for a method for chemical detection issued Oct. 2, 1997 to Daryl Sunny Mileaf and Noe Esau Rodriquez, II provides the following state of the art information: “a method for detecting a target substance which includes collecting a substance sample; introducing the substance sample into a substance card having at least one preselected reagent responsive to the presence of the target substance and having a light-transmissive chamber; and inserting the substance card into a substance detector device having a photosensor and adapted to receive the substance card. Once the substance detector card has been inserted into the substance detector, the method continues by mixing the substance sample with the preselected reagents for a preselected mixing period, thus producing a measurand having a target substance reaction.”

U.S. Pat. No. 6,470,730 for a dry transfer method for the preparation of explosives test samples issued Oct. 29, 2002 to Robert Chamberlain provides the following state of the art information: “. . . method of preparing samples for testing explosive and drug detectors of the type that search for particles in air. A liquid containing the substance of interest is placed on a flexible Teflon® surface and allowed to dry, then the Teflon® surface is rubbed onto an item that is to be tested for the presence of the substance of interest. The particles of the substance of interest are transferred to the item but are readily picked up by an air stream or other sampling device and carried into the detector.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The Griess reagent is used in colormetric detection of nitrogen-oxide species. Whether the source of the nitrogen are biological systems (such as cell function), or in chemical systems (such as high explosives), the Griess reagent reacts with nitrogen oxides to produce a highly colored azo-dye which is used as a simple indicator. Although widely used in many commercial and research applications, the Griess reagent has only limited storage lifetime, typically 1 to 4 months, due to decomposition which produce colored impurities, rendering it unusable for detection. The present invention provides a method in which to treat the Griess reagent to improve storage lifetimes at room temperature or higher to over a year or more. This method greatly extends the useful lifetime of preparations of the Griess reagent as well as broadens the applications to field testing equipment.

The present invention provides a method for stabilizing Griess reagent comprising the steps of providing the Griess reagent, and stabilizing the Griess reagent. In one embodiment, the present invention provides a method for stabilizing Griess reagent comprising the steps of providing the Griess reagent and stabilizing the Griess reagent by removing ambient atmosphere. In another embodiment, the present invention provides a method for stabilizing Griess reagent comprising the steps of providing the Griess reagent and stabilizing the Griess reagent by removing ambient atmosphere wherein the step of stabilizing the Griess reagent by removing ambient atmosphere comprises removing ambient atmosphere with an inert gas.

The present invention has use as a stand alone rapid test for explosives to be used by field and laboratory personnel to determine the presence and types of explosives. The present invention is of interest to the US Military, EPA, Law enforcement, and other civilian agencies needing explosives identification and forensic analysis. Long storage lifetimes are necessary. In private industry the present invention has uses in an explosives detection kit. Also, many companies sell Griess reagent kits for biochemical applications. Long storage lifetimes would greatly increase the commercial value.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1A shows a bottle containing a freshly prepared Griess reagent.

FIG. 1B shows a bottle containing the same Griess reagent stored in tightly sealed closed containers at room temperature after 30 days.

FIG. 2 is a graph that shows UV-visible spectrum of vacuum sealed Griess reagent ampoules at room temperature and at 60° C.

FIG. 3 shows one of the samples after 230 days.

FIG. 4 illustrates an inspection tester for explosives utilizing the present invention.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

The ability to identify unknown explosives in the field is of utmost importance to the military, law enforcement and Homeland Security forces worldwide. Spot tests for the identification of explosives have been used in combination with thin-layer chromatography and in forensic analysis. There are some commercial companies (Mistral, Securesearch, Duram products) who have produced explosives identification kits similar to LLNL technology. They have incorporated similar color reagents and have been used by the military and law-enforcement agencies. They allow the identification of nitroaromatics, nitramines, ammonium nitrate, and recently the potassium chlorate-based explosives. Their systems are available as spray kits or solution-drop kits.

Key to the explosive testing technology described above is the Griess reagent. Known since 1879, the Griess reagent reacts with nitrogen oxide compounds, whether bound or free, and produces a highly colored compound that can be used for visible detection. This colored compound has been shown to be an effective indicator for not only high explosives, but other source of nitrogen oxides, such as biological systems.

Although known and used commercially and in research for over a century, the Griess reagent exhibits an intrinsic instability that has not ever been fully addressed. This instability lessens the effectiveness of the use of the Griess reagent due to reducing its storage life significantly.

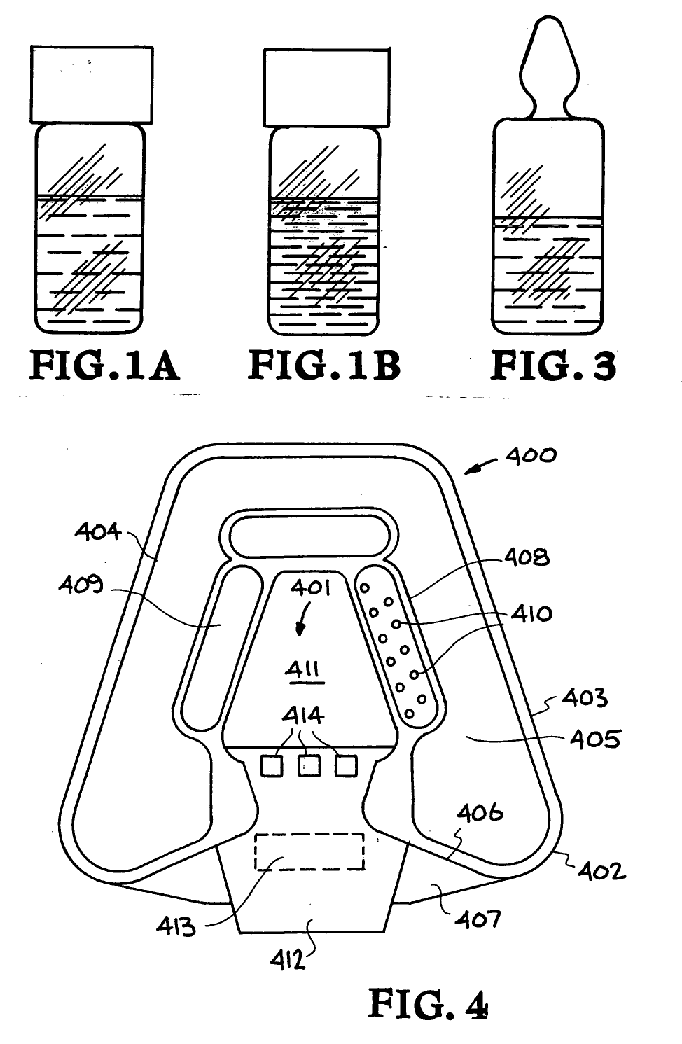

This instability is demonstrated in FIGS. 1A and 1B. FIG. 1A shows a bottle containing a freshly prepared Griess reagent. As illustrated in FIG. 1A, the solution is colorless. FIG. 1B shows a bottle containing the same Griess reagent stored in tightly sealed closed containers at room temperature after 30 days. The FIG. 1B sample is visibly colored. This color is sufficient enough and covers the visible spectrum in such a way that it will interfere with precise indication of the presence of nitrogen oxides. Similarly, if the reagent is stored where the container is not tightly sealed, the interfering color becomes highly intense in the same amount of time, making the reagent completely unusable.

The amount of colored compound formed depends upon the method of sealing the container, and the temperature of storage. Under normal storage conditions, no matter how carefully the preparation is done, the Griess reagent will produce this color. Commercial producers of the reagent recognize the instability. A typical instruction (taken for the product catalog of a vendor) on handling the Griess reagent are as follows: Store at 4° C.; keep all solutions in their original light-protective plastic bottles; return to refrigerator as soon as possible; storage lifetime is about 4 months.

The present invention provides a set of simple methods that will stabilize the Griess reagent towards the formation of the colored interfering compounds shown. to be formed in normal and commercial preparations of the Griess reagent. In all preparations, the Griess reagent is prepared by the method of J. B. Fox (Analytical Chemistry, 51(9), 1493 (1979)). This is not meant to limit the method of synthesis, just to give an example. Other published methods are just as adequate. The example of the method of stabilizing the reagent is also shown as an example and is not meant to limit the methods of stabilization.

A 2-gram solution of Griess reagent was placed in a 5 mL glass ampoule. The ampoule was then connected to a vacuum line. The ampoule was then frozen in liquid nitrogen. When the solution was completely frozen, the system was pumped out until no gas evolved further. The ampoule was then isolated from the vacuum system. The ampoule was let to thaw to room temperature. The whole process was repeated two more times. After pumping down the third time, the neck of the ampoule was sealed with a torch and the ampoule was then thawed. Several ampoules were prepared this way. Some were left at room temperature and some were placed in a constant heating bath at 60° C. to accelerate the formation of the colored interference. (An accelerated aging method has been developed to reduce the evaluation time from months to one day.) After 6 months, all the ampoules that were properly sealed exhibited no evidence of the formation of the colored interference.

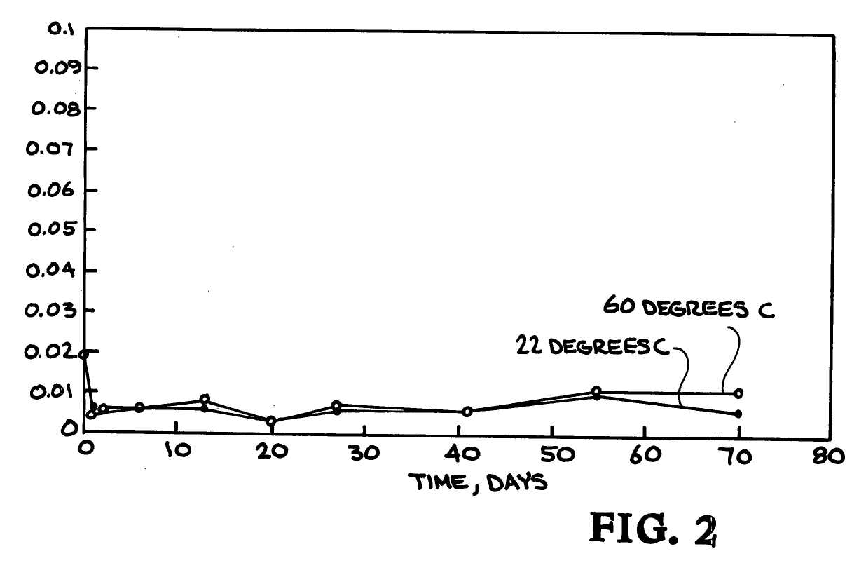

FIG. 2 shows one example this study. In this study, the ampoules are still colorless after 300 days and are currently still being studied. FIG. 2 is a graph that shows UV-visible spectrum of vacuum sealed Griess reagent ampoules at room temperature and at 60° C. Data extends to at least 300 days as on 5.8.05 and is currently being monitored.

FIG. 3 shows a photograph of one of the samples after 230 days. The color impurity is monitored at 500 nm by a UV-vis spectrometer. In addition, all samples that were not correctly sealed very quickly exhibited dark color within 24 hours in the accelerated aging study. Clearly, the Griess reagent preparation that includes the vacuum treatment step produces a stabilized Griess reagent that does not produce the colored interference.

The above is just one method of stabilizing the Griess reagent. This example was used to develop analysis protocols. Several other methods of stabilization are just as effective and are preferred because of ease of application. Preferred methods are purging the bulk preparation of the Griess reagent with purified inert gases such as nitrogen, argon, helium. In these methods, 100 grams of Griess reagent are prepared by literature methods. The whole batch is then placed into a flask that can be isolated from ambient air, preferably with a serum stopper, and pure nitrogen is bubbled through the system. The length of time for bubbling depended upon the ambient conditions under which the Griess reagent is prepared. Once the bulk reagent was purged, samples were transferred by cannula to smaller vials and these vials were analyzed in the accelerated aging test. No sample has yet to show the colored interference after one month at 60° C. This translates to storage lifetimes of well over one year at room temperature.

Referring now to FIG. 4, an embodiment of the present invention is illustrated in connection with an inspection tester for explosives. This embodiment of the present invention is designated generally by the reference numeral 400. The inspection tester 400 is an all-inclusive, inexpensive, and disposable device. The inspection tester can be used anywhere as a primary screening tool by non-technical personnel to determine whether a surface contains explosives. The inspection tester 400 was developed to allow identification of explosives. This inspection tester may be used by first responders, military, law enforcement and Homeland Security.

The inspection tester 400 provides a small, disposable, one-use system. The inspection tester 400 uses a simple and rapid method of operation. A removable swab unit sample pad 401 is exposed to a suspect substance. This may be accomplished by the swab unit sample pad 401 being swiped across a surface containing the suspect substance or the swab unit pad 401 may be exposed to the suspect substance in other ways such as adding the suspect substance to the swab unit sample pad 401.

The inspection tester 400 comprises an explosives tester body 402 and the removable swab unit 401 adapted to be removably positioned in the explosives tester body 402. The removable swab unit 401 includes a lateral flow membrane 411, an area 412 so that the swab unit can be easily inserted and removed from the explosives tester body 402. The removable swab unit 401 also includes an information area 413 and color reaction indicators 414.

The explosives tester body 402 includes a printable backing card 403 that adds stiffness and infographics. A heat seal pattern 404 adds strength to avoid warping. A section 405 of the explosives tester body 402 provides an area for printed graphics and thumb placement and step numbering. The explosives tester body 402 includes a beveled docking entry portion 406 and a tab 407 for easy docking of the removable swab unit sample pad 401.

The explosives tester body 402 includes Meisenheimer Complexes ampoule 408 and Griess Reagent ampoule 409. In various embodiments, Meisenheimer Complexes ampoule 408 and Griess Reagent ampoule 409 are breakable ampoules, breakable glass ampoules, squeezable ampoules, and other types of ampoules. As shown in FIG. 4, Meisenheimer Complexes ampoule 408 includes indentations 410 on the chamber which keeps glass pieces from adhering to the walls.

The lateral flow membrane 411 makes up the bulk of the removable swab unit 401. The lateral flow membrane 411 comprises a microporous membrane that provides migration of fluids from Meisenheimer Complexes ampoule 408 and fluids from Griess Reagent ampoule 409. Lateral flow membranes are known for their use in other fields such as blotting techniques, enzyme-linked immunosorbent assay (ELISA) testing, and lateral-flow immunochromatographic tests. The lateral flow membrane 411 is a Porex Lateral-Flo Membrane. The lateral flow membrane 411 comprises polyethylene spheres fused into a Lateral-Flo™ membrane. Applicants experimentally determined that the properties of Porex make it an ideal swipe material for the inspection tester 400. The lateral flow membrane 411 is chemical resistant, withstands heat as high as 430° C., is durable, is inexpensive, can be cut to any size, and concentrates suspect materials along the solvent front making calorimetric detection limits. The lateral flow membrane 411 provides a high surface area swipe for sample collection.

Meisenheimer Complexes ampoule 408 and Griess Reagent ampoule 409 provide two reagent activation units. Meisenheimer Complexes ampoule 408 (for reagent A) and Griess Reagent ampoule 409 (for reagent B) are operatively mounted on the explosives tester body 402. The Meisenheimer Complexes ampoule 408 containing the first explosives detecting reagent A is positioned to deliver the first explosives detecting reagent A to the lateral flow membrane 411. The Griess Reagent ampoule 409 containing the second explosives detecting reagent B is positioned to deliver the second explosives detecting reagent B to the lateral flow membrane 411. The reagent A contains Meisenheimer Complexes ampoule. The reagent B provides a Griess reaction. The present invention provides a system wherein the Griess reagent is connected to a vacuum in preparation. The present invention provides a system to treat the Griess reagent to improve storage lifetimes at room temperature or higher to over a year or more. The present invention greatly extends the useful lifetime of preparations of the Griess reagent as well as broadens the applications to field testing equipment.

The inspection tester 400 uses a simple and rapid procedure summarized by the following four step operation:

STEP 1) A suspect surface is swiped with the removable swab unit sample pad 401. This may be accomplished by the swab unit sample pad 401 being swiped across a surface containing the suspect substance or the swab unit pad 401 may be exposed to the suspect substance in other ways such as adding the suspect substance to the swab unit sample pad 401. This will cause any explosives residue to be collected and held by the swab unit sample pad 401.

STEP 2) The breakable or squeezable Meisenheimer Complexes ampoule 408 is located in a position to deliver the first explosives detecting reagent A to the lateral flow membrane 411. The breakable or squeezable Meisenheimer Complexes ampoule 408 is pressed to break or squeeze it thereby dispensing reagent A onto the lateral flow membrane 411. The regent A contacts any explosives residue that has been collected by the swab unit sample pad 401. The lateral flow membrane 411 concentrates suspect materials along the solvent front. If the swab unit sample pad 401 becomes colored, the test is positive for explosives. If no color appears, the test for explosives is negative to this point.

STEP 3) If STEP 2 is negative to this point, the inspection tester 400 is positioned in the portable heating unit 300. The heating unit 300 is activated. This causes the swab unit sample pad 401, reagent A, and any explosives residue to become heated. If the swab unit sample pad 401 now becomes colored, the test is positive for explosives. If no color appears, the test for explosives is negative to this point.

STEP 4) The breakable or squeezable Griess Reagent ampoule 409 is located in a position to deliver the second explosives detecting reagent B to the lateral flow membrane 411. If STEP 3 is negative to this point, the breakable or squeezable Griess Reagent ampoule 409 is pressed to brake or squeeze it thereby dispensing reagent B onto the lateral flow membrane 411. The regent B contacts any explosives residue that has been collected by the swab unit sample pad 401., The lateral flow membrane 411 concentrates suspect materials along the solvent front. If the swab unit sample pad 401 becomes colored, the test is positive for explosives. If no color appears, the test for explosives is negative.

In the embodiment of the present invention 400, the Griess reagent is used in colormetric detection of nitrogen-oxide species. Whether the source of the nitrogen is biological systems (such as cell function), or in chemical systems (such as high explosives), the Griess reagent reacts with nitrogen oxides to produce a highly colored azo-dye which is used a simple indicator. Although widely used in many commercial and research applications, the Griess reagent has only limited storage lifetime, typically 1 to 4 months, due to decomposition which produce colored impurities, rendering it unusable for detection.

The embodiment of the present invention 400 provides a system wherein the Griess reagent is connected to a vacuum in preparation. The present invention provides a system to treat the Griess reagent to improve storage lifetimes at room temperature or higher to over a year or more. The present invention greatly extends the useful lifetime of preparations of the Griess reagent as well as broadens the applications to field testing equipment. The present invention provides a method comprising the steps of stabilizing a Griess reagent. In one embodiment the method of stabilizing a Griess reagent comprises stabilizing a Griess reagent by removing ambient atmosphere. In one embodiment the method of stabilizing a Griess reagent comprises removing ambient atmosphere with a vacuum. In one embodiment the method of stabilizing a Griess reagent comprises removing ambient atmosphere with an inert gas.

The present invention has use in connection with a stand alone rapid test for explosives used by field and laboratory personnel to determine the presence and types of explosives. The present invention is expected to have use to the US Military, EPA, Law enforcement, and other civilian agencies needing explosives identification and forensic analysis. The present invention is expected to have use to companies that sell Griess reagent kits for biochemical applications.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. A method for stabilizing Griess reagent, comprising the steps of:
providing the Griess reagent, and
stabilizing the Griess reagent.

2. The method for stabilizing Griess reagent of claim 1 wherein said step of stabilizing the Griess reagent comprises stabilizing the Griess reagent by removing ambient atmosphere.

3. The method for stabilizing Griess reagent of claim 1 wherein said step of stabilizing the Griess reagent comprises removing ambient atmosphere with a vacuum.

4. The method for stabilizing Griess reagent of claim 1 wherein said step of stabilizing the Griess reagent comprises removing ambient atmosphere with an inert gas.

5. A method for stabilizing Griess reagent, comprising the steps of:
providing the Griess reagent, and
stabilizing the Griess reagent by removing ambient atmosphere.

6. The method for stabilizing Griess reagent of claim 5 wherein said step of stabilizing the Griess reagent by removing ambient atmosphere comprises freezing the Griess reagent and removing ambient atmosphere with a vacuum.

7. A method for stabilizing Griess reagent, comprising the steps of:
providing the Griess reagent, and
stabilizing the Griess reagent by removing ambient atmosphere, wherein said step of stabilizing the Griess reagent by removing ambient atmosphere comprises removing ambient atmosphere with an inert gas.

8. The method for stabilizing Griess reagent of claim 7 wherein said step of removing ambient atmosphere with an inert gas comprises removing ambient atmosphere with a purified inert gas.

9. The method for stabilizing Griess reagent of claim 7 wherein said step of removing ambient atmosphere with an inert gas comprises removing ambient atmosphere with nitrogen.

10. The method for stabilizing Griess reagent of claim 7 wherein said step of removing ambient atmosphere with an inert gas comprises removing ambient atmosphere with argon.

11. The method for stabilizing Griess reagent of claim 7 wherein said step of removing ambient atmosphere with an inert gas comprises removing ambient atmosphere with helium.
